(19) United States
(12) Patent Application Publication
(10) Pub. No.: US 2006/0018509 A1
(43) Pub. Date: Jan. 26, 2006

(54) Image generation device

(76) Inventors: Takashi Miyoshi, Atsugi (JP); Hidekazu Iwaki, Tokyo (JP); Akio Kosaka, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/177,983

(22) Filed: Jul. 8, 2005

(30) Foreign Application Priority Data
Jul. 20, 2004 (JP) 2004-211371

(51) Int. Cl. G06K 9/00

(52) U.S. Cl. 382/104

(57) ABSTRACT

In a device for generating one viewpoint conversion image based on a plurality of image data, a first unit including two cameras with different viewpoints, for acquiring one of the image data, and a second unit, including two cameras with different viewpoints, which is arranged in line with the first unit so that the first and second units are in a positional relationship where the optical axis direction of a imaging lens of at least one of the two cameras included in the second unit is parallel to the optical axis direction of a imaging lens of one of the cameras included in the first unit, for acquiring the other one of the image data are provided. The units are arranged so that the imaging lenses of the two cameras included in the first and the second units have optical axes which are not parallel to each other.

### CROSS REFERENCE TO RELATED APPLICATIONS

This application claims benefit of Japanese Application No. 2004-211371, filed Jul. 20, 2004, the contents of which are incorporated by this reference.

### BACKGROUND OF THE INVENTION

1. Field of the Invention

The present invention relates to an image generation device, and particularly to an image generation device suitable for generating and displaying a viewpoint conversion image based on a plurality of images.

2. Description of the Related Art

When images are displayed on a monitor display for purposes of an observation of a particular area or the like, images acquired by imaging a wide range of areas by a plurality of cameras are displayed on a divided screen, or such images are displayed by being sequentially switched as time elapses. Also, for a safe drive, a camera facing backward is provided on a vehicle for imaging an area which a driver can not directly or indirectly view so that the image of the area is displayed on a monitor display provided near a driver's seat.

These observation devices image and display the images in a unit of a camera, accordingly, imaging of a wide area requires a larger number of cameras. When a wide angle camera is used for this purpose, the number of cameras can be reduced, however, a resolution of the image displayed on a monitor display is lowered and the displayed image becomes difficult to be viewed, so that the observation function is worsened. Taking these problems into consideration, a technique is proposed in which images imaged by a plurality of cameras are synthesized to be displayed as one image.

Upon this synthesis, depth data is acquired by measuring the distances between a vehicle and obstacles or the like around the vehicle, and the image is generated by using the depth data for displaying the obstacles in the image.

Regarding the technique such as the above, in Japanese Patent No. 3286306, a technique is disclosed in which the area around a vehicle is imaged by a plurality of cameras provided in the vehicle and a synthesized image from an arbitrary viewpoint is displayed for displaying the situation around the vehicle. In this technique, image output from each camera is transformed and developed onto the two-dimensional plane viewed from a virtual viewpoint by a coordinate transformation in a unit of a pixel, and images by the plurality of the cameras are synthesized into one image viewed from the virtual viewpoint in order to be displayed on a monitor screen. Thereby, it can be instantaneously understood by a driver based on one virtual viewpoint image what kind of objects there are entirely around the vehicle. And, a method is disclosed in which upon the above, a barrier wall is displayed in a spatial model based on a distance between the vehicle and obstacles being around the vehicle, which distance is measured by a range sensor.

Also, in Japanese Patent Application Publication No. 2002-31528, a method is disclosed in which depth data is acquired by measuring distance by using laser rader, and image data acquired by a imaging unit is mapped on the three-dimensional map coordinate in order to generate the spatial image.

### SUMMARY OF THE INVENTION

A device in one aspect of the present invention is a device comprising a first panoramic camera unit, including two cameras with different viewpoints, for acquiring one of the image data, and a second panoramic camera unit, including two cameras with different viewpoints, which is arranged in line with the first panoramic camera unit so that the first and second panoramic camera units are in a positional relationship where the optical axis direction of a imaging lens of at least one of the two cameras included in the second panoramic camera unit is parallel to the optical axis direction of a imaging lens of one of the cameras included in the first panoramic camera unit, for acquiring the other image data, in which the imaging lenses of the two cameras included each in the first and the second panoramic camera units have optical axes which are not parallel to each other.

Additionally, the above device according to the present invention can employ a configuration in which the device further comprises a switching unit for switching a selection between panoramic image data acquired by two cameras included in one of the first and the second panoramic camera units, and stereo image data acquired by a combination of the cameras, among the cameras included in the first and the second panoramic camera units, which are in the positional relationship where the optical axes directions thereof are parallel to each other.

Additionally, upon the above, the switching unit can employ a configuration in which the switching unit further selects one of two pairs of the cameras when the switching unit selects the stereo image data acquired by the combination of the cameras, among the cameras included in the first and the second panoramic camera units, which are in the positional relationship where the optical axes directions thereof are parallel to each other.

Also, in the above device according to the present invention, the first and the second panoramic camera units can be arranged in a vehicle or in a building.

### BRIEF DESCRIPTION OF THE DRAWINGS

The present invention will be more apparent from the following detailed description when the accompanying drawings are referenced.

FIG. 1 is a system block diagram of an image generation device for implementing the present invention;

FIG. 2A shows a schematic configuration of a first example of a panoramic camera unit;

FIG. 2B shows a schematic configuration of a second example of the panoramic camera unit;

FIG. 3A shows an arrangement configuration of the panoramic camera unit based on a combination of monocular cameras;

FIG. 3B shows panoramic imaging scopes by the panoramic imaging unit shown in FIG. 3A;

FIG. 4A shows an arrangement configuration of a pair of the panoramic camera units based on the combination of the monocular cameras;

FIG. 4B shows panoramic imaging scopes by one of the panoramic camera units in pair shown in FIG. 4A;

FIG. 4C shows panoramic imaging scopes by the other of the panoramic camera units in pair shown in FIG. 4A;

FIG. 5A shows an arrangement configuration of the panoramic camera unit which uses a stereo adapter;

FIG. 5B shows panoramic imaging scopes by the panoramic camera unit shown in FIG. 5A;

FIG. 6A shows an arrangement configuration of a pair of the panoramic camera units using the stereo adapters;

FIG. 6B shows panoramic imaging scopes by one of the panoramic camera units in pair shown in FIG. 6A;

FIG. 6C shows panoramic imaging scopes by the other of the panoramic camera units in pair shown in FIG. 6A;

FIG. 7 shows a configuration of provisions of the panoramic camera units in a vehicle;

FIG. 8A shows a panoramic imaging scope of a first panoramic camera unit at a rear portion of the vehicle;

FIG. 8B shows the panoramic imaging scope of a second panoramic camera unit at the rear portion of the vehicle;

FIG. 8C shows a stereo imaging scope based on the combination of the panoramic camera units at the rear portion of the vehicle;

FIG. 9 is a flowchart for showing a process order in a method of generating image; and

FIG. 10 is a flowchart for showing a process order in a generation of depth image processed by stereo matching.

### DESCRIPTION OF THE PREFERRED EMBODIMENTS

Hereinafter, embodiments for the image generation device according to the present invention will be explained in detail by referring to the accompanying drawings.

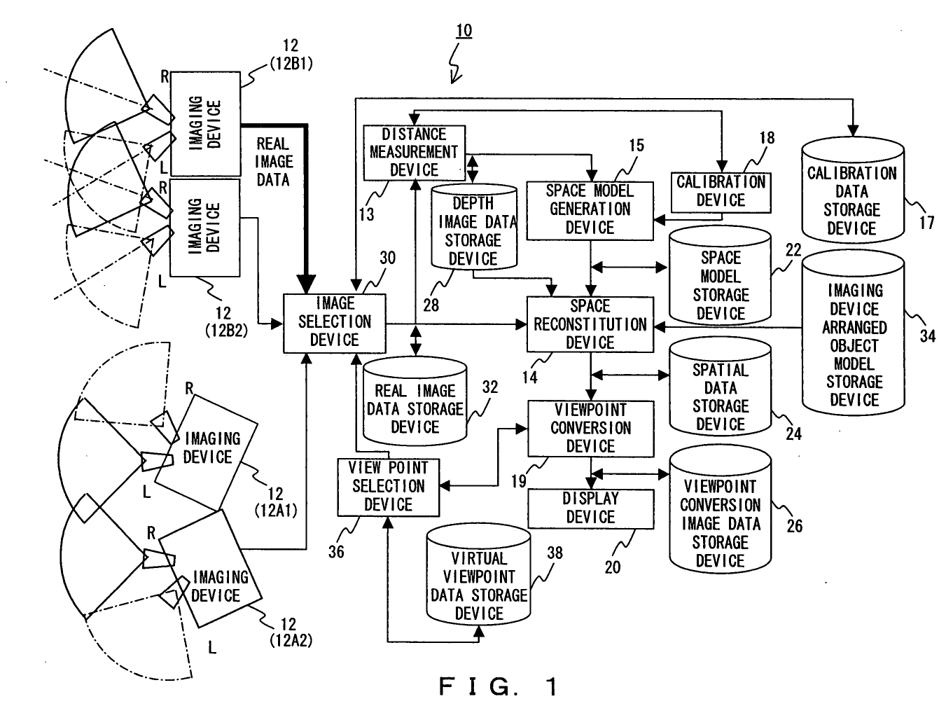

FIG. 1 is a system block diagram showing a configuration of an image generation device for implementing the present invention. The basic configuration of this system is provided with a viewpoint conversion synthesized image generation/display device 10 comprising a plurality of imaging units, an image generation device for processing image data acquired by the imaging units and reproducing and displaying the image as a synthesized image viewed from a virtual viewpoint which is different from the viewpoint of the camera.

Basically, the viewpoint conversion synthesized image generation/display device 10 executes a process of inputting images imaged from viewpoints of respective imaging units, a process of setting a three-dimensional space in which a imaging unit arranged object such as a vehicle is placed, a process of identifying this three-dimensional space by an arbitrarily set origin (virtual viewpoint), a process of conducting a coordinate transformation on pixels of the image data and making a correspondence between the above identified three-dimensional space viewed from the virtual viewpoint and the pixels, and a process of rearranging pixels on an image plane viewed from the virtual viewpoint. Thereby, an image in which the pixels of the image data acquired by the imaging from the viewpoint of the camera are rearranged and synthesized in the three-dimensional space defined by the virtual viewpoint can be obtained so that the synthesized image from a desired viewpoint which is different from the viewpoint of the camera can be created and output to be displayed.

As the imaging unit to be used in the viewpoint conversion synthesized image generation/display device 10, one or a plurality of imaging units are constituted by panoramic camera units made each by combining two cameras having different viewpoints.

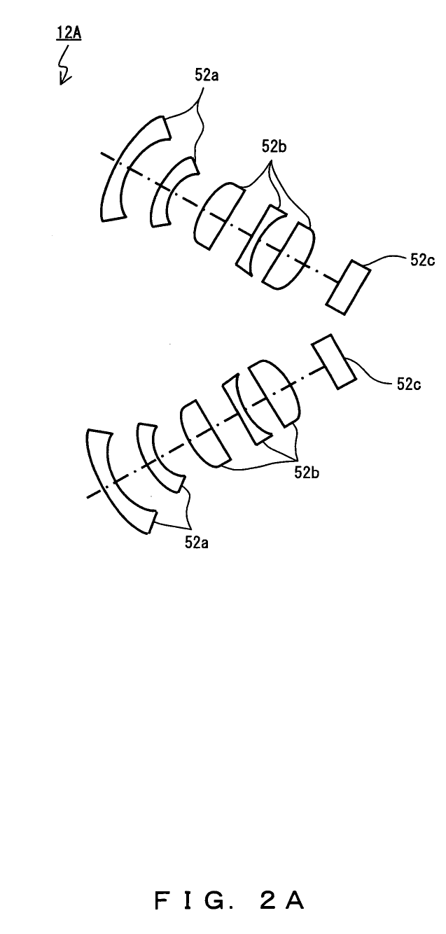

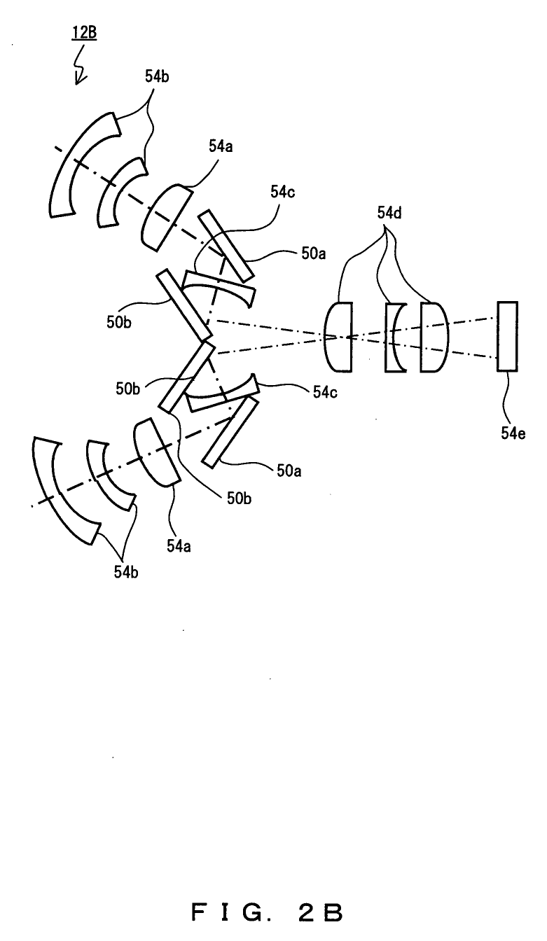

FIG. 2A and FIG. 2B respectively show schematic configurations of the panoramic camera units. A plurality of the panoramic camera units arranged in a vehicle are constituted by either type of the panoramic camera unit 12A shown in FIG. 2A and a panoramic camera unit 12B shown in FIG. 2B or based on a combination of the units 2A and 2B.

The panoramic camera unit 12A has a configuration in which two monocular cameras each comprising a front lens group 52a, a rear lens group 52b and an imaging device 52c are arranged. The two monocular cameras are arranged so that the convergence angle between optical axes is opened for imaging a wide area. Additionally, when it is not necessary that the angle of view is wide, a group of wide conversion lenses corresponding to the front lens group 52a is not required.

The panoramic camera unit 12B includes a stereo adapter provided in the monocular camera. The stereo adapter is mounted in front of the monocular camera, and the convergence angle between the right and left optical axes of the monocular cameras is opened via the stereo adapter. The stereo adapter is constituted by two mirrors 50a arranged at positions away from the stereo adapter about by the parallax, and two mirrors 50b for guiding the light reflected by these mirrors 50a to a side of the camera.

On front optical axes of the two mirrors 50a and 50b which are arranged on the right and left sides, relay lenses 54a and front lens groups 54b are set. Further, a relay lens 54c is set each between the mirror 50a and the mirror 50b. Further, on rear optical axes of the mirrors 50b, rear lens group 54d which is an imaging system is set.

The panoramic camera unit 12B divides a field of view by the mirrors 50a and 50b and images the field of view on one imaging device 54e. It is natural that when the angle of view is not need to be wide, it is possible that the wide conversion lens group corresponding to the front lens group and the relay lenses 54a and 54c are omitted so that this portion of the panoramic camera unit 12B can be constituted only by the mirrors 50a and 50b, and the rear lens group 54d.

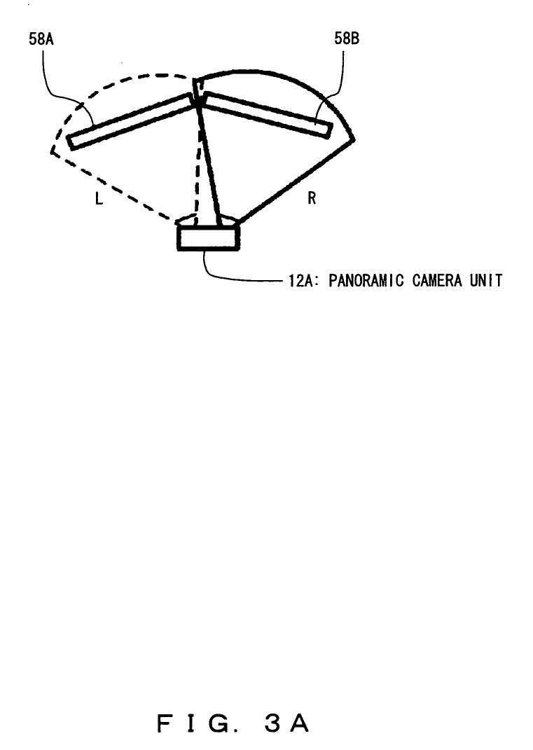

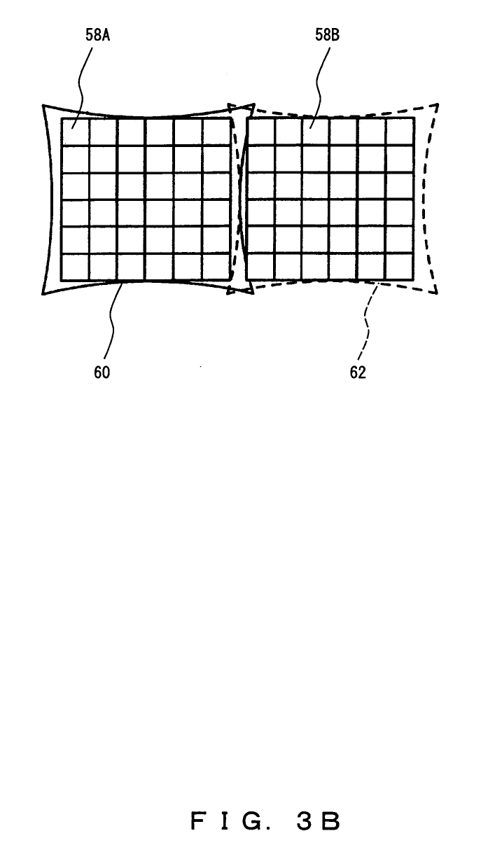

FIG. 3A shows an arrangement configuration of the panoramic camera unit based on the combination of the monocular cameras. The panoramic camera unit 12A has a configuration in which two monocular cameras are arranged on one and the same plane with wide angles of view so that the angles of view slightly overlap each other as shown by two sectors L and R each expressing the angle of view of the camera in FIG. 3A.

Right and left panoramic imaging scopes in the case where lattice patterns 58A and 58B are imaged by the panoramic camera unit 12A based on the combination of monocular cameras are shown, which are respectively denoted by numerals 60 and 62 in FIG. 3B. The image imaged by the panoramic imaging suffers from the distortions in which the peripheries of the images are greatly rounded. However, in the panoramic image in FIG. 3B, the distortions of the lattice patterns are compensated so that the images are displayed including concaves.

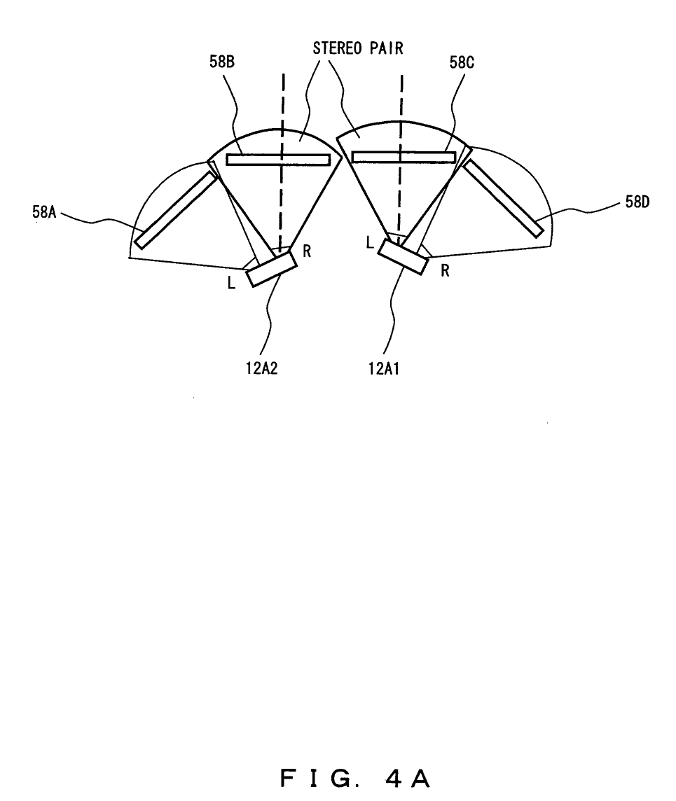

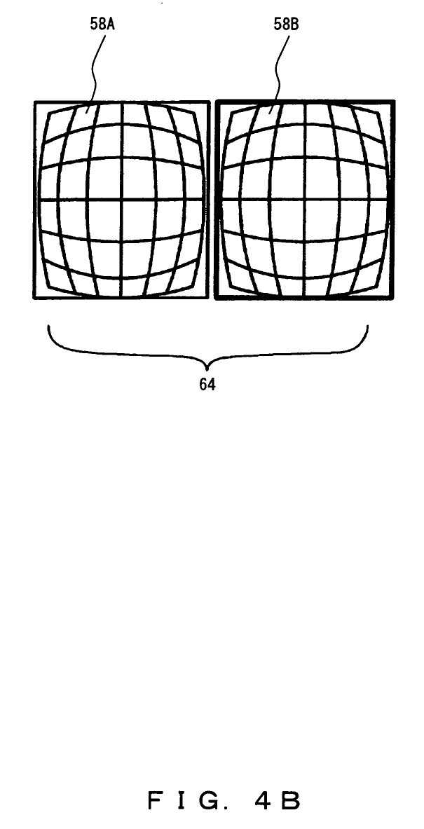

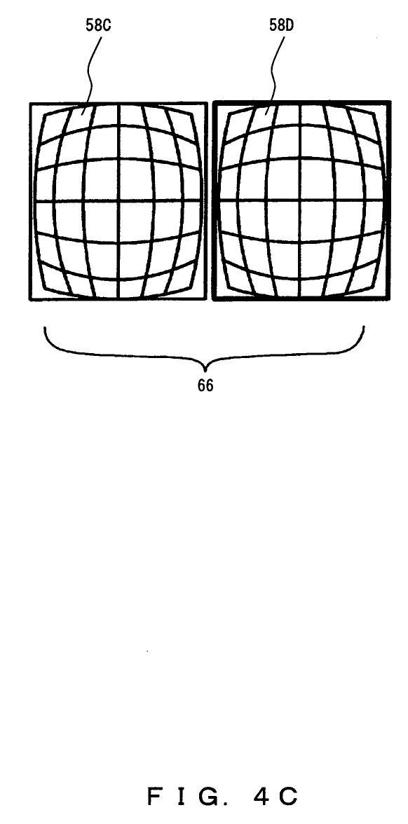

FIG. 4A shows an arrangement configuration of a pair of the panoramic camera units based on the combinations of the monocular cameras. When the panoramic camera units 12A1 and 12A2 are arranged as shown in FIG. 4A, an arrangement is employed so that the directions of the optical axes respectively of the left monocular camera of the panoramic camera unit 12A1 and the right monocular camera of the panoramic camera unit 12A2 are parallel to each other. Thereby, a stereo imaging can be conducted by combining the left monocular camera of the panoramic camera unit 12A1 and the right monocular camera of the panoramic camera unit 12A2.

The images imaged respectively by the panoramic camera units 12A1 and 12A2 are shown respectively as an image 64 in FIG. 4B and an image 66 in FIG. 4C. Both of the images 64 and 66 include generally the same distortions in the lattice patterns, accordingly, both distortions can be expressed by approximate models so that the parameters for compensation of the distortions are approximate to each other. Accordingly, a rectification process which includes a compensation of the distortion aberration of the right and left images of the stereo image based on the calibration data upon the stereo distance measurement and in which a geometric conversion of the images is conducted so that the epipolar lines upon the calculation of the parallax correspond to each other on one and the same line of one and the same image of right and left images, can be simplified.

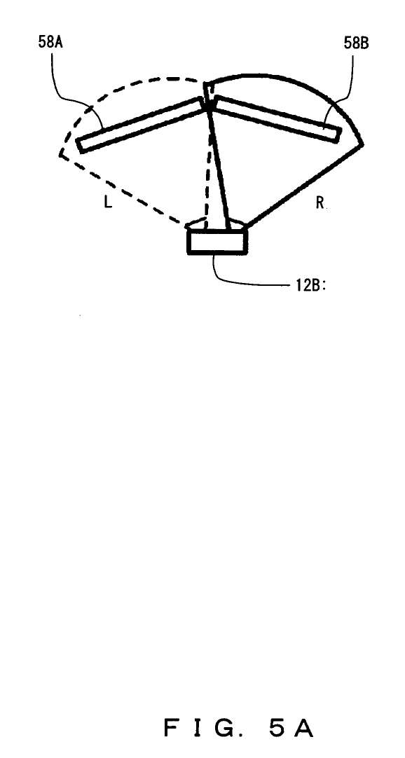

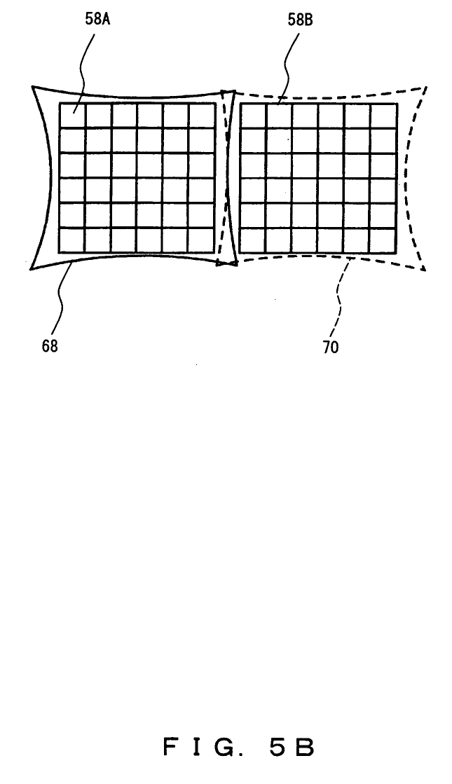

FIG. 5A shows an arrangement configuration of the panoramic camera unit which uses the stereo adapter. In FIG. 5A, the panoramic camera unit 12B is arranged similarly to the arrangement in the above described FIG. 3A so that the right and left imaging scopes slightly overlap each other. Right and left panoramic imaging scopes in the case where lattice patterns 58A and 58B are imaged by the panoramic camera unit 12B are shown in FIG. 5B, which are respectively denoted by numerals 68 and 70. Because of the stereo adapter, only one imaging device imaged the same field of view as that imaged by the above described panoramic camera unit 12A comprising two imaging devices. Therefore, as shown, the distortions in the lattice patters at the right and left sides of the peripheries of the images are different from those in the images imaged by the panoramic camera unit 12A.

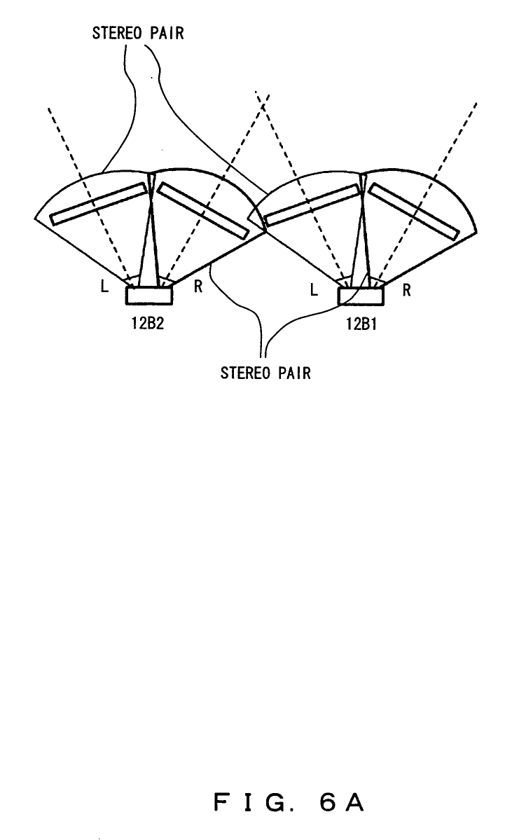

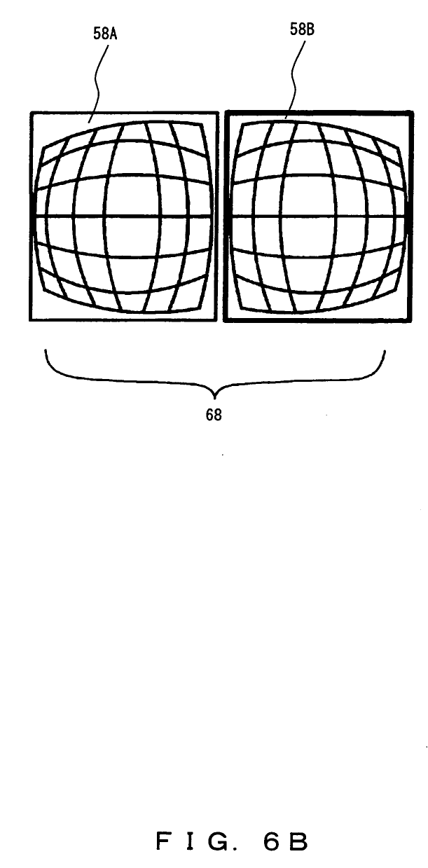

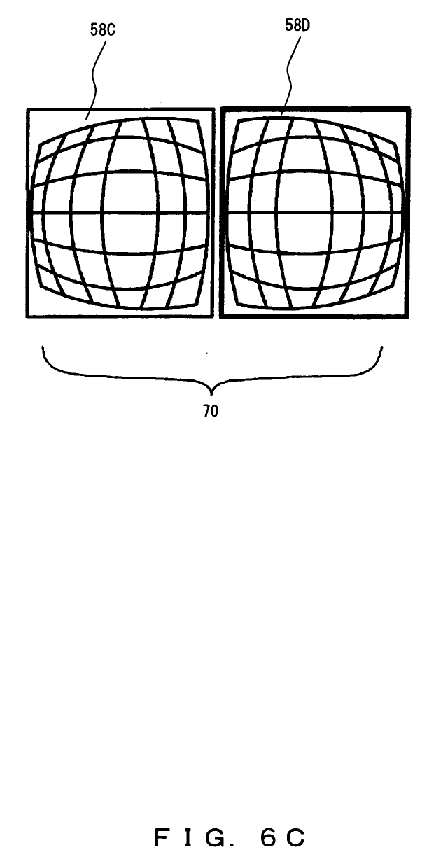

FIG. 6A shows an arrangement configuration of a pair of the panoramic camera units using the stereo adapters. In FIG. 6A, the two panoramic camera units 12B1 and 12B2 are arranged in line on one and the same plane. Thereby, the directions of the optical axes of the imaging lenses based on the combination of the pair of the right side units respectively of the panoramic camera units 12B1 and 12B2 are parallel to each other, and also, the directions of the optical axes of the imaging lenses based on the combination of the pair of the left side units respectively of the panoramic camera units 12B1 and 12B2 are parallel to each other. Accordingly, a stereo imaging can be conducted.

Images imaged respectively by the panoramic camera units 12B1 and 12B2 are shown which are respectively denoted by the numerals 68 in FIGS. 6B and 70 in FIG. 6C. As shown, the images imaged by the panoramic camera unit 12B which employ the configuration that the convergence angles between the optical axes are opened by changing angles of the mirrors of the stereo adapters suffer from distortions which greatly differ between the right image and the left image (58A and 58B, or 58C and 58D). The reasons for these differences in distortions are that complex distortions are generated by the distortion of the front lens group 54b and the distortion of the rear lens group 54d having the folding mirror 50b therebetween, and that the optical axes are not parallel to each other. These are the reasons for the differences in distortions between the right and left images.

Accordingly, when a divided field of view based on the combination of the right side units respectively of the panoramic camera units 12B1 and 12B2, or a divided field of view based on the combination of the left side units respectively of the panoramic camera units 12B1 and 12B2 is used, the distortions are approximate to each other and the resolution difference after the distortion compensation is smaller, therefore, the search for the corresponding points of the stereo image becomes easier.

Additionally, the panoramic camera unit serving as the imaging unit in FIG. 1 has the configuration in which a pair of the panoramic camera units 12A including two imaging devices 52c or a pair of the panoramic camera units 12B using the stereo adapters is employed. And these pairs of the units (a pair of 12A1 and 12A2 in FIG. 1, and a pair of 12B1 and 12B2) can be arbitrarily selected.

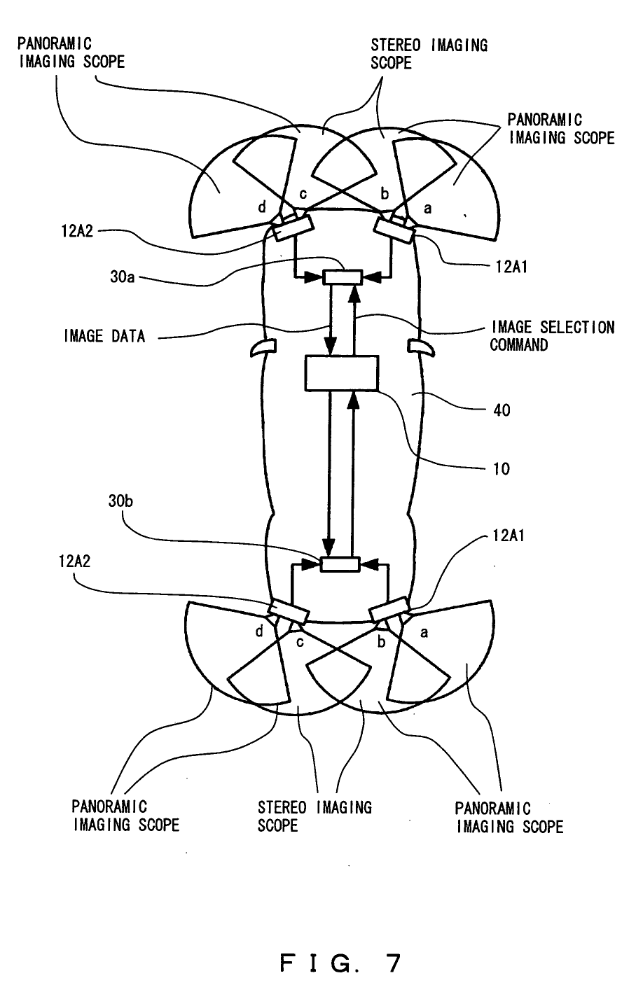

FIG. 7 shows a configuration of provisions of the panoramic camera units 12A on a vehicle.

As shown in FIG. 7, a plurality of the panoramic camera units 12A as the imaging units are provided at front and rear portions of a vehicle 40 as an object in which the imaging units are arranged. In an example of FIG. 7, the panoramic camera units 12A1 and 12A2 are provided at the front portion of the vehicle 40. The respective cameras image the panoramic imaging scopes a-b and c-d in front of the vehicle 40. Also, the panoramic camera units 12A1 and 12A2 as the imaging units are provided at the rear portion of the vehicle. Similarly, the respective cameras image the panoramic imaging scopes a-b and c-d behind the vehicle.

In this embodiment, image selection devices 30 (30a and 30b) for taking in image data from the panoramic camera units 12A1 and 12A2 arranged in the front and rear portions of the vehicle 40 are provided. Each of the image selection devices 30 receives an image selection command from the viewpoint conversion synthesized image generation/display device 10 provided in the vicinity of a driver's seat, selects the necessary image, and returns the image as the image data to the viewpoint conversion synthesized image generation/display device 10. Additionally, transmission/reception of the data can be conducted via an in-vehicle LAN (Local Area Network).

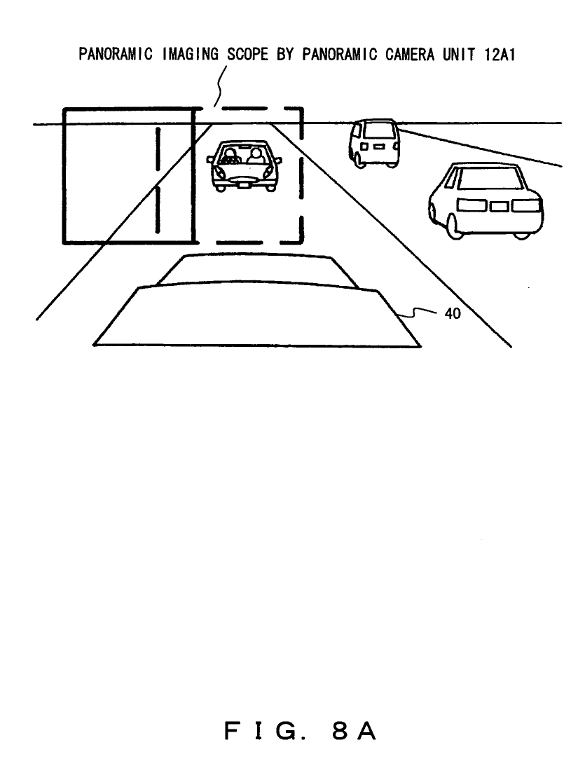

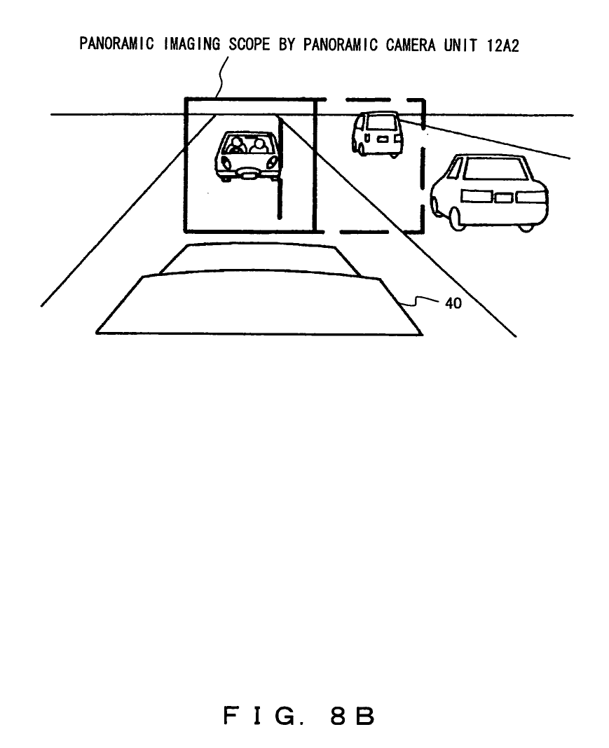

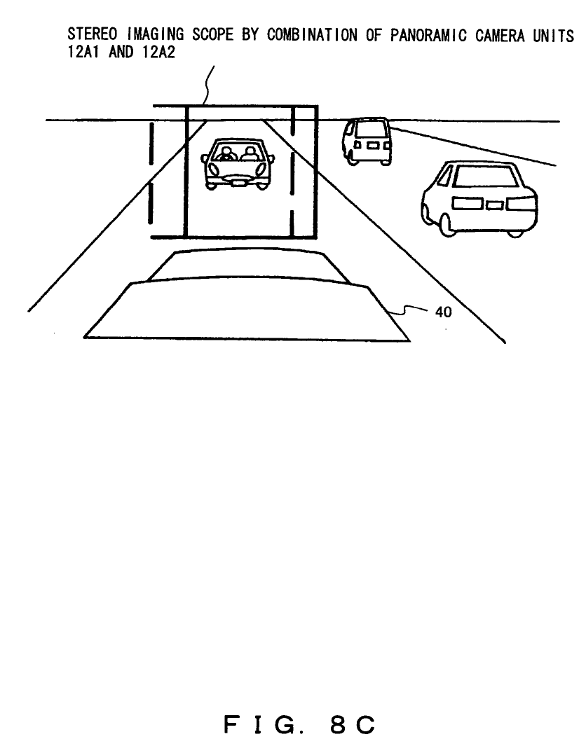

FIGS. 8A, 8B and 8C respectively show the imaging scopes of the panoramic camera and the stereo camera according to an embodiment. FIG. 8A shows the panoramic imaging scope of the rear panoramic camera unit 12A1 in the vehicle 40. FIG. 8B shows the panoramic imaging scope of the rear panoramic camera unit 12A2. FIG. 8C shows a stereo imaging scope based on the combination of the image with the imaging scope b of the rear panoramic camera unit 12A1 and the imaging scope c of the rear camera unit 12A2. As shown, the combination of the image with the imaging scope b of the rear panoramic camera unit 12A1 and the imaged image with the imaging scope c of the panoramic unit 12A2 constitutes a stereo image because the arrangement is made so that the directions of the optical axes of the imaging lenses are parallel. Accordingly, the depth image data by the stereo imaging which will be described later can be generated.

Additionally, by the switching of the selection of the images by the image selection device 30, the imaging with the wide angle of view by the panoramic imaging and the stereo distance measurement for generating the spatial model by the spatial imaging can be arbitrarily implemented.

Again, FIG. 1 is explained.

The data of the images imaged by the respective panoramic camera units 12 is transmitted in packets to the image selection device 30. The image data that has to be obtained from the respective panoramic camera units 12 is determined by the set virtual viewpoint, therefore, the image selection device 30 is provided for obtaining the image data corresponding to the set virtual viewpoint. By the image selection device 30, the image data packet corresponding to the set virtual viewpoint is selected from the image data packets transmitted from a buffer device (not shown) provided in an arbitrary panoramic camera unit 12, and is used for an image synthesis process executed in a later stage.

Also, in the imaging unit, the switching among the plurality of the panoramic camera units 12 is conducted by the image selection device 30. In the image selection device 30 serving as a control unit, switching is conducted between the imaging with the wide angel of view by the panoramic camera unit 12 and the stereo imaging constituted by a combination of a pair of the panoramic camera units. Also, the image selection device 30 controls the switching between the imaging with the wide angle of view and the stereo imaging based on the virtual view point selected by the view point selection device 36 which will be described later. Further, regarding the panoramic camera units 12B, switching can be conducted in order to image from one of the right and left fields of view respectively of the two cameras which are arranged so that directions of the optical axes of the imaging lenses are parallel.

Data of real image imaged by the imaging unit is temporarily stored in a real image data storage device 32.

By the way, for a distance measurement device 13 serving as a distance measurement unit, a distance measurement by the stereo imaging and a distance measurement by a radar such as a laser radar, a millimeter wave radar or the like can be used together.

In the distance measurement by the stereo imaging, one and the same object is imaged from a plurality of different viewpoints, the correspondence among the imaged images regarding one and the same point on the object is obtained, and the distances to the object are calculated based on the above correspondence by using the principle of the triangulation. More specifically, the entirety of the right image of the images imaged by the stereo imaging unit is divided into small regions and the scope about which the stereo distance measurement calculation is executed is determined, next, the position of the image which is recognized to be the same as the right image is detected from the left image. Then, the parallax of these images is calculated, and the distances to the object are calculated from the relationship among the above calculation result and the mounting positions of the right and left cameras. Based on the depth data obtained by the stereo distance measurement among two or more images imaged by the stereo camera, the depth image (as distance measurement image) is generated.

Also, a calibration device 18 determines and identifies camera parameters, which specify the camera's characteristics, such as a mounting position of the imaging unit in a three-dimensional real world, a mounting angle, lens distortion compensation value, a focal length of a lens and the like, regarding the imaging unit arranged in the three-dimensional real world. The camera parameters obtained by the calibration device 18 are temporarily stored in a calibration data storage device 17 as the calibration data.

In a spatial model generation device 15, a spatial model is generated based on the image data of the wide angle of view by the panoramic camera units 12 and the stereo imaging, and the depth image data by the distance measurement device 13 which is stored in a depth image data storage device 28. The generated spatial model is temporarily stored in a spatial model storage device 22.

A space reconstitution device 14 serving as a synthesized image generation unit generates the spatial data by calculating the correspondence between respective pixels constituting the image acquired by the imaging unit and the points on the three-dimensional coordinate system. The generated spatial data is temporarily stored in a spatial data storage device 24. Additionally, this calculation of the correspondence is executed for all the pixels in the image acquired by the respective imaging units.

A viewpoint conversion device 19 serving as a viewpoint conversion unit converts an image of a three-dimension space into an image estimated from an arbitrary viewpoint position. Additionally, the viewpoint position can be arbitrarily specified. In other words, the position, the angle and the magnification for viewing the image are specified in the above described three-dimensional coordinate system. Also, the image viewed from current viewpoint is reproduced from the above described spatial data, and the reproduced image is displayed on a display device 20 serving as a display unit. Also, this image can be stored in a viewpoint conversion image data storage device 26.

Additionally, in the viewpoint conversion synthesized image generation/display device 10, a imaging device arranged object model storage device 34 storing a model of the corresponding vehicle is provided for displaying, on the display device 20, the model of the corresponding vehicle simultaneously with the reproduction of the space. Also, the view point selection device 36 is provided so that when image data corresponding to the set virtual viewpoint which is defined beforehand is held in a virtual viewpoint data storage device 38, the corresponding image is transmitted to the viewpoint conversion device 19 instantaneously upon the viewpoint selection process, and the conversion image corresponding to the selected virtual viewpoint is displayed on the display device 20.

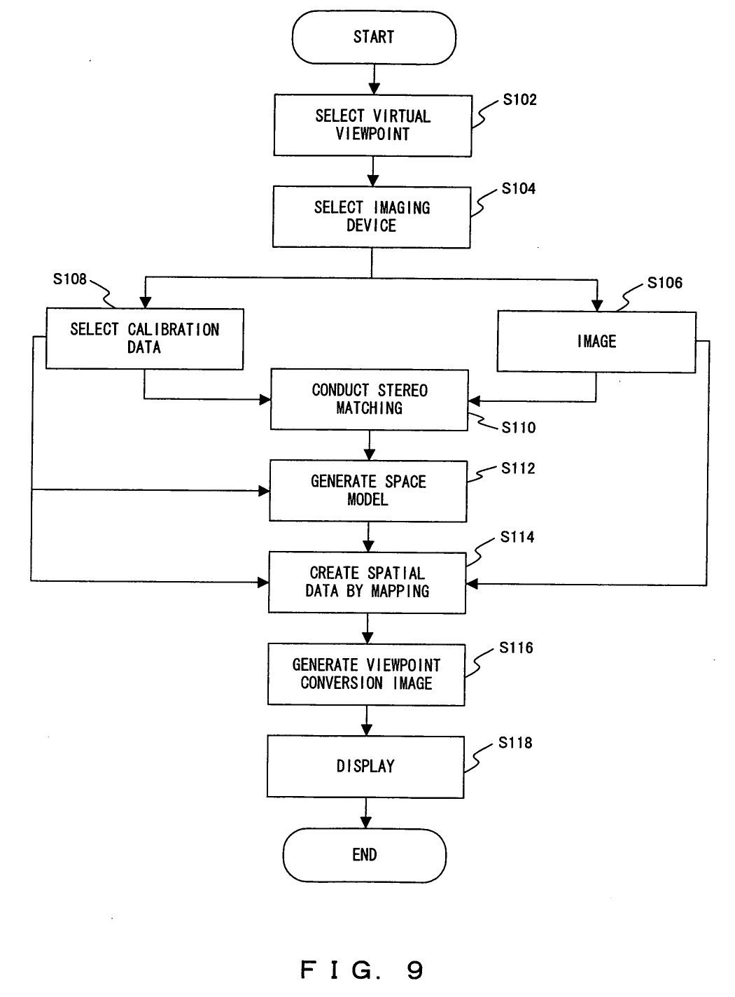

A method of generating images by using the image generation device according to the present invention based on the above configuration will be explained by referring to FIG. 9. FIG. 9 is a flowchart for showing a process order in the method of generating an image.

First, in step S102, an arbitrary virtual viewpoint to be displayed is selected by the view point selection device 36.

In step S104, a selection between imaging with a wide angle of view and a stereo imaging by the plurality of the panoramic camera units 12 is made by the image selection devices 30.

In step S106, an image is conducted by the selected panoramic camera units 12.

On the other hand, in step S108, the calibration to be used for a stereo matching is beforehand conducted by the calibration device 18, and the calibration data such as baseline length in accordance with the selected panoramic camera units 12, internal and external camera parameters and the like is created.

In step S110, a stereo matching of the selected image is conducted by the distance measurement device 13 based on the acquired calibration data. Specifically, the prescribed windows are cut out from the right and left images upon viewing the images as the stereo image, and the correlation value for the regularization and the like of the window images are calculated while scanning the epipolar line so that the corresponding points are searched and the parallax between the pixels of the right and left images is calculated. Then, from the calculated parallax, the distance is calculated based on the calibration data, and the obtained depth data is recognized as the depth image data.

In step S112, the image data of the imaging with the wide angle of view and the image data of the stereo imaging by the panoramic camera units 12, and the depth image data obtained by the distance measurement device 13 are input to the space reconstitution device 14 serving as a spatial model update unit, and the above data is selectively used, thereby, a spatial model which is more detailed than the model generated by a spatial model generation device 15 is generated.

In step S114, in order to acquire the real image data corresponding to this spatial model, the image acquired by the imaging unit is mapped to the three-dimensional spatial model in accordance with the calibration data by the space reconstitution device 14. Thereby, spatial data which has been subjected to texture mapping is created.

In step S116, viewpoint conversion image which is viewed from a desired virtual viewpoint is generated by the viewpoint conversion device 19 based on the spatial data created by the space reconstitution device 14.

In step S118, the viewpoint conversion image data generated as above is displayed on the display device 20.

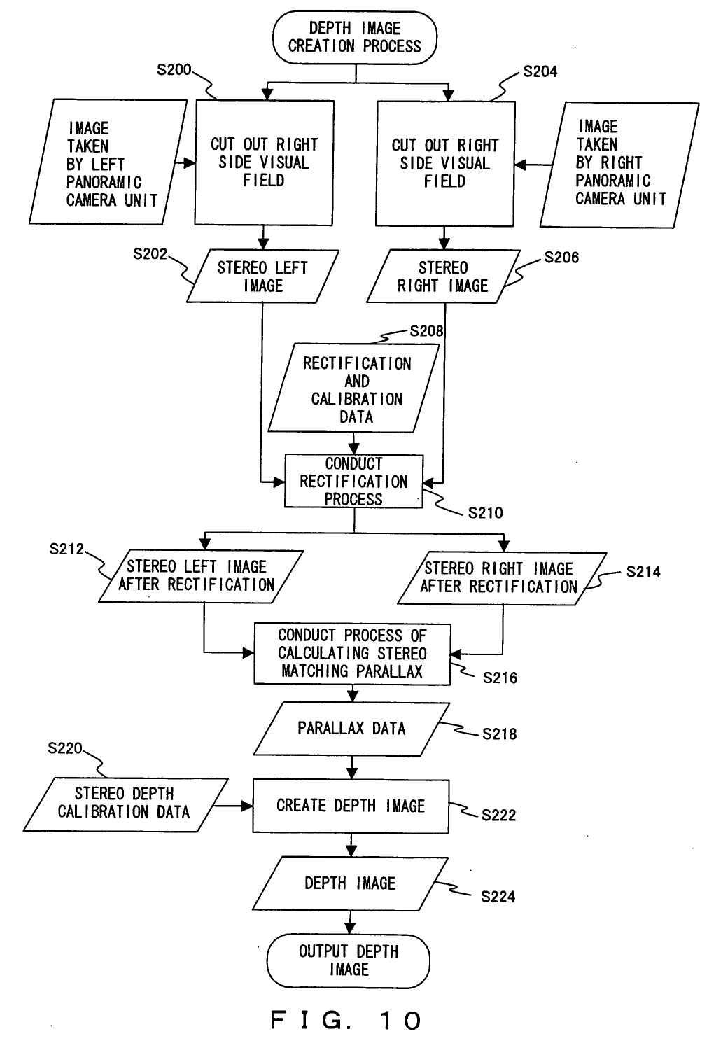

Next, a flowchart for showing a generation of the depth image of the stereo imaging by the stereo matching is shown in FIG. 10. Now, the case is explained where the panoramic camera units 12B1 and 12B2 of the stereo adapter 50 is used, and right side fields of view constituting a stereo pair are selected by the image selection devices 30 among the images imaged by the panoramic camera units 12B1 and 12B2.

First, in steps S200 and S204, the right side field portions of view imaged by the respective stereo camera units 12B1 and 12B2 are cut out in a predetermined size by the image selection devices 30, and a stereo left image (S202) and a stereo right image (S206) are generated.

Next, based on calibration data (S208) for the rectification, the compensation of the distortion aberration respectively of the right and left stereo images is conducted, and the rectification process is conducted in which the images are geometrically converted in order that the corresponding points of the right and left images are on the epipolar line by the distance measurement device 13 in step S210. Additionally, this calibration data is about the baseline length in accordance with the right side cameras respectively of the selected stereo camera units 12B1 and 12B2, internal and external camera parameters and the like, and is beforehand created by conducting the calibration by the calibration device 18.

Next, the stereo matching is conducted on a stereo left image (S212) and a stereo right image (S214) after the rectification, the search is made for the corresponding points, and a process for calculating the parallax is executed by the distance measurement device 13 in step S216. Thereby, a map of the parallax amount at each point on the image is created, and the created map becomes parallax data (S218).

Next, based on stereo depth calibration data (S220), the parallax amount at each point on the image is converted into the distance from a reference point, and a process for creating the depth image data is executed by the distance measurement device 13 in step S222. Additionally, this stereo depth calibration data is about the baseline length in accordance with the right side cameras respectively of the selected stereo camera units 12B1 and 12B2, the internal and external camera parameters and the like, and is beforehand created by conducting the calibration by the calibration device 18.

As above, the data of the depth image (S224) is created and is output.

By conducting the above processes, the depth image data is calculated from the images imaged by the plurality of the stereo cameras. The obtained depth image data is used for creating the spatial model.

As described above, this viewpoint conversion synthesized image generation/display device 10 is a device for generating a viewpoint conversion image based on the image data by one or a plurality of the imaging units provided in a vehicle which employs a configuration in which the imaging unit is constituted by a panoramic camera unit including two cameras with different viewpoints in a combined state, and the imaging with the wide angle of view by the panoramic camera units and the stereo imaging by the combination of the cameras which are arranged so that the optical axes of the imaging lenses are parallel to each other realized by arranging the panoramic camera units in a pair are possible. In other words, this viewpoint conversion synthesized image generation/display device 10 is a device for generating a viewpoint conversion image based on a plurality of the imaging information, comprising a first panoramic camera unit, including two cameras with different viewpoints, for acquiring one of the image data, and a second panoramic camera unit, including two cameras with different viewpoints, which is arranged in line with the first panoramic camera unit so that the first and second panoramic camera units are in a positional relationship where the optical axis direction of the imaging lens of at least one of the two cameras included in the second panoramic camera unit is parallel to the optical axis direction of the imaging lens of at least one of the two cameras included in the first panoramic camera unit, and which acquires one of the image data which is different from the image data acquired by the first panoramic camera unit, and the device 10 employs a configuration in which the optical axes of the imaging lenses of the two cameras included each by the first and the second panoramic camera units are not parallel to each other. Accordingly, the distance measurement to the object on the imaging window can be conducted, and the accuracy in the image generation can be improved by using this depth image data.

Also, a switching unit is provided for switching between a wide angle of view process to be applied to the image acquired by the imaging with the wide angle of view by the panoramic camera units and a stereo imaging process to be applied to the image acquired by the stereo imaging by a combination of the cameras which are arranged in a positional relationship in which the optical axes of the imaging lenses are parallel. In other words, the switching unit is provided for switching between the panoramic image data acquired by two cameras included in one of the first and the second panoramic camera units, and the stereo image data acquired by the combination of the two cameras, among the cameras included in the first and the second panoramic camera units, which are in the positional relationship in which the optical axes directions of the cameras are parallel to each other, thereby, the image data by the imaging with the wide angle of view and the depth image data can be used together with each other, accordingly, the accuracy of the image generation can be improved.

Still further, in the above stereo image process, a switching is possible so that the imaging from one of the right and left fields of view can be conducted by using one of the two pairs of cameras arranged in a two-camera combination positioned in a relationship in which the optical axes directions of the imaging lenses in the paired panoramic camera units are parallel. In other words, when the above described switching unit selects the stereo image data acquired by the combination of the cameras, among the cameras included in the first and the second panoramic camera units, which are in the positional relationship in which the optical axes directions of the cameras are parallel to each other, a selection is further made for selecting one of the above two pairs of the cameras, thereby, in this stereo image process, the imaging can be conducted from the field of view of one of the right and left pairs respectively of the two cameras. Therefore, a common distortion compensation process can be used so that the compensation process is simplified. Accordingly, the spatial model can be created easily.

Also, by arranging the first and the second panoramic camera units in a vehicle, when the virtual viewpoint image generated by the viewpoint conversion synthesized image generation/display device 10 is displayed on a monitor device on the vehicle, the situation around the vehicle can be confirmed in a wide scope, accordingly, the security is greatly improved.

Also, by arranging the imaging units of this viewpoint conversion synthesized image generation/display device 10, i.e. by arranging the first and the second panoramic camera units in a building, the image accuracy can be improved in the image generation of the internal situation and the external peripheral situation of the building.

In addition, in the above embodiment, the plurality of the imaging devices can be used in a configuration where the plurality of the imaging devices constitute a so-called trinocular stereo camera or a quadrinocular stereo camera. It is known that when the trinocular stereo camera or the quadrinocular stereo camera is used as above, the process result which is more reliable and more stable can be obtained in the three-dimensional reproduction process and the like (See “High performance three-dimensional vision system” in the fourth issue of the 42nd volume of “Image processing” by Fumiaki Tomita, published by Information Processing Society of Japan, for example. Especially, the plurality of the cameras are arranged in the directions of two-directional baseline length, a stereo camera which is based on a so-called multi-baseline method is realized, thereby, a stereo measurement with higher accuracy is realized.

Additionally, in the above embodiment, the example where the imaging units such as cameras and the like are provided in a prescribed form in a vehicle, however, the similar implementations of the image generation are possible even when the above imaging units are provided in a walker, a street, a building such as a store, a house, an office or the like serving as the imaging device arranged object. By the above configurations, the present invention can be applied to a wearable computer attached to a monitoring camera or the human body for acquiring image-based information.

Further, the present invention is not limited to the above described embodiments, and various modifications and alternations are allowed without departing from the spirit of the present invention.

What is claimed is:

1. A device for generating one viewpoint conversion image based on a plurality of image data, comprising:
a first panoramic camera unit, including two cameras with different viewpoints, for acquiring one of the image data; and
a second panoramic camera unit, including two cameras with different viewpoints, which is arranged in line with the first panoramic camera unit so that the first and second panoramic camera units are in a positional relationship where the optical axis direction of a imaging lens of at least one of the two cameras included in the second panoramic camera unit is parallel to the optical axis direction of a imaging lens of one of the cameras included in the first panoramic camera unit, for acquiring the other one of the image data, wherein:
the imaging lenses of the two cameras included each in the first and the second panoramic camera units have optical axes which are not parallel to each other.

2. The device according to claim 1, further comprising:
a switching unit for switching a selection between panoramic image data acquired by two cameras included in one of the first and the second panoramic camera units, and stereo image data acquired by a combination of the cameras, among the cameras included in the first and the second panoramic camera units, which are in the positional relationship where the optical axes directions thereof are parallel to each other.

3. The device according to claim 2, wherein:
the switching unit further selects one of two pairs of the cameras when the switching unit selects the stereo image data acquired by the combination of the cameras, among the cameras included in the first and the second panoramic camera units, which are in the positional relationship where the optical axes directions thereof are parallel to each other.

4. The device according to claim 1, wherein:
the first and the second panoramic camera units are arranged in a vehicle.

5. The device according to claim 1, wherein:
the first and the second panoramic camera units are arranged in a building.
